(19) United States
(12) Patent Application Publication
(10) Pub. No.: US 2012/0282431 A1
(43) Pub. Date: Nov. 8, 2012

(54) MIXED POLYESTER YARNS AND ARTICLES MADE THEREFROM

(75) Inventors: Jing-Chung Chang, Garnet Valley, PA (US); Ray W. Miller, Kennett Square, PA (US)

(73) Assignee: E.I. DU PONT DE NEMOURS AND COMPANY, Wilmington, DE (US)

(21) Appl. No.: 13/187,615

(22) Filed: Jul. 21, 2011

Related U.S. Application Data
(60) Provisional application No. 61/366,181, filed on Jul. 21, 2010.

(51) Int. Cl. B32B 3/16; C08L 67/02; D02G 3/04

(52) U.S. Cl. 428/87; 428/401; 428/97; 428/92; 525/437

(57) ABSTRACT

The present invention is directed to polyester yarns made from two or more different polyesters. The invention is also directed to finished articles made from two or more different polyesters, and especially to carpets.

### FIELD OF THE INVENTION

The present invention is directed to polyester yarns made from two or more different polyesters. The invention is also directed to finished articles made from two or more different polyesters, and especially to carpets.

### SUMMARY OF THE INVENTION

One aspect of the present invention is a mixed polyester yarn comprising a first fiber component and a second fiber component, wherein the first fiber component comprises poly(trimethylene terephthalate) filaments and the second fiber component comprises filaments of a second polyester.

Another aspect of the invention is a carpet made from a mixed polyester yarn comprising a first fiber component and a second fiber component, wherein the first fiber component comprises poly(trimethylene terephthalate) filaments and the second fiber component comprises filaments of a second polyester, wherein the carpet comprises at least one of loop pile and cut pile.

A further aspect of the invention is a carpet comprising a first yarn component and a second yarn component, wherein the first yarn component comprises PTT yarns and the second yarn component comprises PET yarns.

These and other aspects of the invention will be apparent to one skilled in the art in view of the following description and the claims.

### DETAILED DESCRIPTION

The present invention provides yarns made from mixtures of polyesters, also referred to as “mixed polyester yarns”. The mixtures can be formed in a variety of ways, as disclosed hereinbelow.

While any compatible polyesters can be used in the yarns, PTT is used as a first polyester in the yarns. In preferred embodiments, the yarns contain poly(ethylene terephthalate) (PET) and/or poly(butylene terephthalate) (PBT) as a second polyester. In some embodiments, the yarns can contain three or more polyesters, wherein PTT is a first polyester and PET is a second polyester.

The present invention also provides carpets made from mixed polyester yarns. The mixed polyester yarns can be made of individual filaments of two or more polyesters. In some embodiments, yarns of first polyester PTT are twisted together with yarns of a second polyester. In some embodiments yarns are formed by twisting together filaments of PTT and a second polyester, and the yarns can be twisted with yarns of PTT and/or another polyester. These and other embodiments are described more fully hereinbelow.

The term “filament” is used herein to refer to a single, continuous fiber made by extrusion from a spinnerette. Polyester filaments typically have a denier up to 30 dpf (denier per filament).

The term “yarn” is used herein to refer to a plurality of filaments. A plurality of filaments can be produced from a single spinnerrette and interlaced together to form a yarn. Alternatively, a plurality of filaments from two or more spinnerrettes can be twisted together to form a yarn.

As used herein, a PTT filament is a filament that contains PTT and can contain up to about 15% of another polyester. Thus, the term “PTT filament”, when used herein, is intended to encompass filaments that are made from 100% PTT, and also filaments that contain up to about 15% of another polyester, which other polyester can be, for example, PET, PTT or PBT.

As used herein, a PET filament can be made of PET hompolymer or copolymer. For example, a copolymer can comprise ethylene glycol and another monomer. For use in embodiments disclosed herein, copolymers typically comprise 100 to 85% ethylene glycol and 0 to 15% (CHDM) cyclohexane dimethanol.

All percentages recited herein are on a weight basis, unless otherwise indicated.

For making finished products such as carpets, yarns are sent to a creel, which is a device that holds bobbins, wherein each bobbin has yarns wound around it. The yarns from the bobbins can be twisted and then heat set together to form a “ready-to-tuft” yarn (referred to herein as RTT). According to embodiments of the present invention, the RTTs are formed from mixed polyester yarns.

According to embodiments of the present invention, yarns and/or RTTs formed from the yarns can comprise filaments of different polyester compositions. The RTTs can be used to make carpets.

Thus, in some embodiments, a plurality of filaments of two or more different polyester compositions, which can comprise a polyester homopolymer and/or a polyester copolymer, can be combined (interlaced) to make a mixed polyester yarn. Alternatively, a plurality of filaments of a single polyester composition can be interlaced with a plurality of filaments of a second, single polyester composition to make a mixed polyester yarn. Thus, a first yarn component containing individual filaments of 0 to 100% poly(trimethylene terephthalate) (PTT) and 100 to 0% another polyester, which can comprise a polyester homopolymer and/or a polyester copolymer, can be combined (twisted) with a second yarn component containing individual filaments of from 0 to 100% of a second polyester and 100 to 0% of PTT. For example, a first yarn containing 30% PTT filaments and 70% filaments of another polyester can be combined (twisted) with a second yarn containing 30% PTT filaments and 70% filaments of another polyester, to form a RTT.

In preferred embodiments the second polyester is PET. Other polyesters that can be used as a second polyester include polybutylterephthalate.

In preferred embodiments, the RTTs contain from 30% to 90% of a first yarn component, the first yarn component containing PTT filaments, and from 70% to 10% of a second yarn component containing PET filaments. The first yarn component can contain, for example, 0 to 15% PET filaments blended within the PTT filaments. Depending on the number of yarns twisted together, an RTT can contain one (or more) yarn(s) with PET (and lighter weight due to lower dpf) and/or one (or more) yarn(s) containing PTT (and heavier due to the higher dpf).

In preferred embodiments, carpets made from the RTTs of mixed polyester yarns contain at least 30% PTT, more preferably at least 40% PTT, and in some highly preferred embodiments, 50% PTT or more. While there is no upper limit to the PTT content, typically the PTT content in the yarns is 90% or less, preferably 80% or less, more preferably 70% or less.

The filaments of PTT can have a range of denier per filament of at least 6 dpf and preferably from 6 to 20 dpf and the PET yarns preferably have a denier per filament of at least 6 dpf. Preferably the PET yarns have a lower dpf than that of the PTT yarns. The lower dpf PET fibers provide for a softer overall feel while the larger dpf PTT fibers provide better crush resistance and durability for wear performance that is desired in quality carpet.

One or more PET yarns can be twisted together with one or more PTT yarns at various twist per inch (tpi) with typical from 3 to 9. Alternatively, PET or PTT yarns can be twisted together by themselves from 3-9 tpi.

For making carpet, a bulked continuous filament (bcf) yarn is typically used. A bcf yarn is typically made up of about 150 individual filaments. Thus, according to embodiments of the present invention a bcf contains individual yarns of different polyesters.

In some alternative embodiments, carpets can be made from staple yarns. Staple yarns are formed from a rope-like structure, called a “tow”, of filaments, which are then cut into staple fiber lengths of about 1 to 6 inches. To make a tow, a plurality of filaments, e.g., about 150 filaments, from different spinnerets are interlaced together into a tow. The filaments can be of the same or different polyester compositions. Typically each tow is crimped, dried and heatset and then cut into the desired staple length before the staple is combined with staple from another tow. The staple yarns are thus blended into a tow For example, a tow of PTT filaments and a tow of PET filaments, each cut into staple length, can be blended together to form a mixture, which is then combed into a batt, which in turn is drawn into a sliver and used to make a yarn.

Carpets made from RTTs of mixed polyester yarns can be made in a variety of ways. For example, a carpet can be made from two yarn components, wherein the first yarn component is made from PTT yarns as defined herein (i.e., containing up to about 15% of a polyester other than PTT) and the second yarn component is made from yarns of PET, PBT, or another polyester. The yarn components can be distributed within the carpet in a variety of ways. For example, a pattern can be formed by the distribution of the two yarn components and the components can have a different appearance due to differences in dyeing characteristics of the polyesters within the two components of the carpet.

Carpet can be constructed with twisted PTT/PET yarns or mixture of twisted PTT yarns and twisted PET yarns, in a structure comprising 0 to 100% loop pile with 100 to 0% cut pile. In some embodiments, the carpets comprise up to 25% loop pile and up to 75% cut pile. Alternatively, the carpet can have a loop pile portion and a cut pile portion, wherein the loop pile portion is constructed of twisted PET and the cut pile portion is constructed of twisted PTT. Such types of construction, including both cut pile and loop pile, can provide a cost advantage due to the use of lower cost PET, while retaining the durability and resiliency associated with using PTT, thus achieving benefits from both yarns. Dye systems can be either single dyes in which carpet can be dyed with one color recipe but produce a mixture of lighter and darker tones or in some embodiments can use a mixture of polyester dyes with different dye activation temperatures to obtain a single tone result.

Carpets made from mixed polyesters provide advantages over conventional single-component polyester fiber yarns in carpets, including: 1) yarns and carpets can be made that have polyester system compatible recyclability; 2) reduction in overall cost can be realized, as compared to carpets made entirely from PTT or nylon; 3) permanent stain resistance can be provided; 4) wear performance in carpets made from the yarns can be equal to or better than that of 100% nylon carpet; 5) the yarns are typically faster-drying than nylon; 6) the yarns have dyeing properties that allow for new styles and enhanced appearance; 7) better light and bleach fastness than nylon carpets can be obtained by virtue of using more durable polyester-dispersed dyes rather than the organic acid dyes used for nylons; 8) better dimensional stability can be obtained due to less moisture-related yarn swelling; 9) carpets can have a softer feel than PET carpets made with the same construction, and 10) carpets made from the yarns can be dyed in the same dye process using the same or blended polyester dispersed dyes.

As an alternative to dyes, the yarns can be colored by including pigments in the polyester during extrusion. Yarns colored by this process are known in the art as “producer colored yarn”.

1. A mixed polyester yarn comprising a first fiber component and a second fiber component, wherein the first fiber component comprises poly(trimethylene terephthalate) filaments and the second fiber component comprises filaments of a second polyester.

2. The mixed polyester yarn of claim 1 wherein the second polyester is poly(trimethylene terephthalate).

3. The mixed polyester yarn of claim 1, wherein the first fiber component comprises at least about 85% by weight of poly(trimethylene terephthalate) filaments based on the total weight of the first fiber component.

4. The mixed polyester yarn of claim 1 wherein the yarn comprises from 30% to 90% by weight of the first fiber component and from 70% to 10% by weight of the second fiber component, based on the total weight of the mixed polyester yarn.

5. The mixed polyester yarn of claim 1 wherein the first fiber component comprises filaments having a denier of at least 6 dpf.

6. The mixed polyester yarn of claim 1 wherein the second fiber component comprises filaments having a denier of at least 6 dpf.

7. The mixed polyester yarn of claim 1 wherein the first fiber component comprises two or more fibers comprising poly(trimethylene terephthalate).

8. A carpet comprising a mixed polyester yarn of claim 1.

9. A carpet made from a mixed polyester yarn of claim 1, wherein the carpet comprises at least one of loop pile and cut pile.

10. A carpet of claim 9, comprising loop pile yarns and cut pile yarns, wherein the loop pile yarns comprise poly(ethylene terephthalate) filaments and the cut pile yarns comprise poly(trimethylene terephthalate) filaments.

11. A carpet comprising a first yarn component and a second yarn component, wherein the first yarn component comprises PTT yarns and the second yarn component comprises PET yarns.

12. A carpet made from staple yarns, wherein the staple yarns comprise PTT and a second polyester.

13. The carpet of claim 11 wherein the second polyester is PET.

14. A carpet made from a mixed polyester yarn of claim 1, wherein the carpet is colored by pigment coloring during polyester extrusion.

15. A carpet made from a mixed polyester yarn of claim 1, wherein the carpet is colored by dispersed dye.
